(19) United States
(12) Patent Application Publication
(10) Pub. No.: US 2021/0248590 A1
(43) Pub. Date: Aug. 12, 2021

(54) Data Processing Method Implemented Based On NFC Tag, System And Tag Receiving Terminal Thereof

(71) Applicant: CHINA UNIONPAY CO., LTD., Shanghai (CN)

(72) Inventors: Zhijun LU, Shanghai (CN); Haijian JIANG, Shanghai (CN); Gang LIU, Shanghai (CN); Jinren LIN, Shanghai (CN); Hua CAI, Shanghai (CN); Zheng ZHANG, Shanghai (CN); Kewei JIN, Shanghai (CN); Qin XIA, Shanghai (CN)

(73) Assignee: China Unionpay Co., Ltd., Shanghai (CN)

(21) Appl. No.: 17/250,063

(22) PCT Filed: Jul. 8, 2019
(86) PCT No.: PCT/CN2019/094981

§ 371 Date: Nov. 16, 2020

(30) Foreign Application Priority Data
Dec. 12, 2018 (CN) 201811516955.7

(51) Int. Cl. G06Q 20/32; G06Q 20/38

(52) U.S. Cl. CPC G06Q 20/3278; G06Q 20/389

(57) ABSTRACT

The invention relates to a data processing method and a system based on NFC tag. The method comprises: acquiring amount data; generating custom order number for identifying a transaction; issuing tag data application request based on original NFC tag data, acquired amount data and custom order number; generating updated NFC tag data based on tag data application request and saving custom order number, and setting payment state for custom order number to be the unpaid state; updating the NFC tag based on the updated NFC tag data to obtain an updated NFC tag, wherein the updated NFC tag includes amount data; and reading the updated NFC tag and completing payment processing based on updated NFC tag. According to embodiments of the invention, it does not require transaction amount to be input by the user's mobile phone terminal, but instead, transaction amount is obtained by tag receiving terminal through input device.

### FIELD OF THE INVENTION

The invention relates to the computer technology, and in particular, to a data processing method implemented based on NFC tag, a system and a tag receiving terminal thereof.

### BACKGROUND OF THE INVENTION

In carrying out the NFC tag payment project and on trial of relevant products, it is discovered that there are improvements still to be made in the tag payment acceptance environment. For example, the existing NFC tag payment scheme is as follows: after the user's mobile phone terminal comes close to the NFC tag, the user enters transaction amount on the mobile phone terminal (for the case of a tag of a variable amount) to complete payment, which increases the complexity of user operation, degrades the user's payment experience, and increases difficulty for a merchant to confirm payment.

The information disclosed in the background section of the invention is intended merely to increase the understanding of the overall background of the invention and should not be taken as an admission or a suggestion in any form that such information constitutes prior art known to those of ordinary skill in the art.

### SUMMARY OF THE INVENTION

In view of the above, for the above issues, it is intended to provide a data processing method implemented based on NFC tag, a system and a tag receiving terminal thereof which do not require the user to enter the transaction amount.

The data processing method implemented based on NFC tag according to one aspect of the invention comprises:

an amount data acquisition step to acquire amount data;

a custom order number generation step to generate a custom order number for identifying a transaction, wherein a payment state for the custom order number is set to be an unpaid state when the transaction is not paid, and is set to be a state of successful payment after the transaction is completed;

a tag data application step to issue a tag data application request based on original NFC tag data, the acquired amount data and the custom order number;

a tag data reply step to generate updated NFC tag data based on the tag data application request and save the custom order number, and set the payment state for the custom order number to be the unpaid state;

a tag updating step to update the NFC tag based on the updated NFC tag data and generate an updated NFC tag, wherein the updated NFC tag includes the amount data; and

a tag payment step to read the updated NFC tag, complete payment processing based on the updated NFC tag, and change the payment state for the custom order number to the state of successful payment under the condition that the payment is successful.

The data processing method implemented based on NFC tag according to one aspect of the invention comprises:

an amount data acquisition step to acquire amount data;

a custom order number generation step to generate a custom order number for identifying a transaction, wherein a payment state for the custom order number is set to be an unpaid state when the transaction is not paid, and is set to be a state of successful payment after the transaction is completed;

a tag data application step to issue a tag data application request based on original NFC tag data, the acquired amount data and the custom order number;

a tag data reply receiving step to receive a tag data reply based on the tag application request, wherein for the tag data reply, generate updated NFC tag data based on the tag data application request; and

a tag updating step to update the NFC tag based on the updated NFC tag data to obtain an updated NFC tag for payment processing, wherein the updated NFC tag includes the amount data.

The data processing method implemented based on NFC tag according to one aspect of the invention comprises:

an amount data acquisition step to acquire amount data;

a custom order number generation step to generate a custom order number for identifying a transaction, wherein a payment state for the custom order number is set to be an unpaid state when the transaction is not paid, and is set to be a state of successful payment after the transaction is completed;

a tag updating step to update the NFC tag data based on the amount data and the custom order number to obtain an updated NFC tag, wherein the updated NFC tag comprises the amount data; and

a tag payment step to read the updated NFC tag, complete issuing a payment request based on the updated NFC tag and receive a payment reply, wherein the payment request further includes the custom order number and the payment state for the custom order number, and change the payment state for the custom order number to a state of successful payment under the condition that the payment is successful.

The data processing method implemented based on NFC tag according to one aspect of the invention comprises:

an amount data acquisition step to acquire amount data;

a custom order number generation step to generate a custom order number for identifying a transaction, a payment state for the custom order number being set to be an unpaid state when the transaction is not paid, and being set to be a state of successful payment after the transaction is completed; and

a tag updating step to update the NFC tag data based on the amount data and the custom order number to generate an updated NFC tag for payment processing, wherein the updated NFC tag includes the amount data.

The data processing system implemented based on NFC tag according to one aspect of the invention comprises: an external input device, a tag receiving terminal, a handheld payment terminal and a tag payment system,

the external input device being for inputting amount data and providing the amount data to the tag receiving terminal,

the tag receiving terminal comprising:

an NFC tag module for storing NFC tag data;

an MCU for generating a custom order number for identifying a transaction, wherein a payment state for the custom order number is set to be an unpaid state when the transaction is not paid (preferably being set simultaneously), on the other hand, for issuing a tag data application request to the tag payment system based on original NFC tag data, amount data provided by the external input device, and the custom order number to acquire updated NFC tag data as described below, and for updating an NFC tag in the NFC tag module based on the updated NFC tag data as described below acquired from the tag payment system to generate an updated NFC tag, wherein the updated NFC tag includes the amount data,

the tag payment system being for generating the updated NFC tag data according to the tag data application request from the tag receiving terminal and saving the custom order number, and for setting the payment state for the custom order number as an unpaid state; and on the other hand, changing the payment state for the custom order number into a state of successful payment when the transaction corresponding to the custom order number is paid successfully,

the handheld payment terminal being for reading the updated NFC tag from the tag receiving terminal and completing payment processing based on the updated NFC tag.

The tag receiving terminal according to one aspect of the invention comprises:

an external or built-in input device for inputting amount data;

an NFC tag module for storing NFC tag data; and

an MCU for generating a custom order number for identifying a transaction, wherein a payment state for the custom order number is set to be an unpaid state when the transaction is not paid, and on the other hand, for issuing a tag data application request based on original NFC tag data, amount data provided by the input device, and the custom order number to acquire updated NFC tag data, and for updating an NFC tag in the NFC tag module based on the acquired updated NFC tag data to generate an updated NFC tag, wherein the updated NFC tag includes the amount data.

The data processing system implemented based on NFC tag according to one aspect of the invention comprises: an external input device, a tag receiving terminal, a handheld payment terminal and a tag payment system,

the external input device being for inputting amount data and providing the amount data to the tag receiving terminal,

the tag receiving terminal comprising:

an NFC tag module for storing NFC tag data; and

an MCU for generating a custom order number for identifying a transaction, wherein a payment state for the custom order number is set to be an unpaid state when the transaction is not paid, and on the other hand, for updating the amount data and the custom order number into the NFC tag data stored in the NFC tag module to generate an updated NFC tag,

the handheld payment terminal being for reading the updated NFC tag, issuing a payment request to the tag payment system based on the updated NFC tag, and receiving a payment reply from the tag payment system, wherein, the payment request further includes the custom order number and the payment state for the custom order number,

the tag payment system being for receiving the payment request from the handheld payment terminal and returning a payment reply to the handheld payment terminal, and changing the payment state for the custom order number to a state of successful payment when the transaction corresponding to the custom order number is paid successfully.

The tag receiving terminal according to one aspect of the invention comprises:

an external or built-in input device for inputting amount data;

an NFC tag module for storing NFC tag data; and

an MCU for generating a custom order number for identifying a transaction, wherein a payment state for the custom order number is set to be an unpaid state when the transaction is not paid, and on the other hand, for updating the amount data obtained by the input device and the custom order number into the NFC tag data stored in the NFC tag module to generate an updated NFC tag.

The computer readable medium according to one aspect of the invention having stored thereon a computer program, wherein the computer program, when executed by a processor, implements the data processing method implemented based on NFC tag as described above.

The computer device according to one aspect of the invention comprises a memory, a processor, and a computer program stored on the memory and executable on the processor, wherein when executing the computer program, the processor implements the data processing method implemented based on NFC tag as described above.

As described above, the data processing method implemented based on NFC tag and the data processing system based on NFC tag according to embodiments of the present invention do not require the user to enter the transaction amount on the mobile phone terminal, but rather let the merchant enter the transaction amount and update it into the NFC tag, thereby reducing the complexity of user operation, enhancing the user's payment experience, and meanwhile, reducing the difficulty for the merchant to confirm payment, and the experience of both the user side and the merchant side can be improved at the same time.

Other features and advantages of the methods and apparatus of the embodiments will more specifically become apparent or be illuminated by the accompanying drawings and the subsequent specific embodiments for illustrating certain principles of embodiments of the invention in conjunction with the accompanying drawings incorporated herein.

### BRIEF DESCRIPTION OF THE DRAWINGS

FIG. 1 is a flow chart representing the data processing method implemented based on NFC tag of one embodiment of the present invention.

FIG. 2 is a block diagram representing the data system implemented based on NFC tag of one embodiment of the present invention.

FIG. 3 is a flow chart representing the data processing method implemented based on NFC tag of another embodiment of the present invention.

FIG. 4 is a block diagram representing the data system implemented based on NFC tag of another embodiment of the present invention.

### DETAILED DESCRIPTION OF THE EMBODIMENT(S) OF THE INVENTION

The following introduces some of the various embodiments of the invention and is intended to provide a basic understanding of the invention. It is not intended to identify key or critical elements of the invention or to define the scope to be protected.

Firstly, the data processing method implemented based on NFC tag and the data processing system implemented based on the NFC tag of one embodiment of the invention are described.

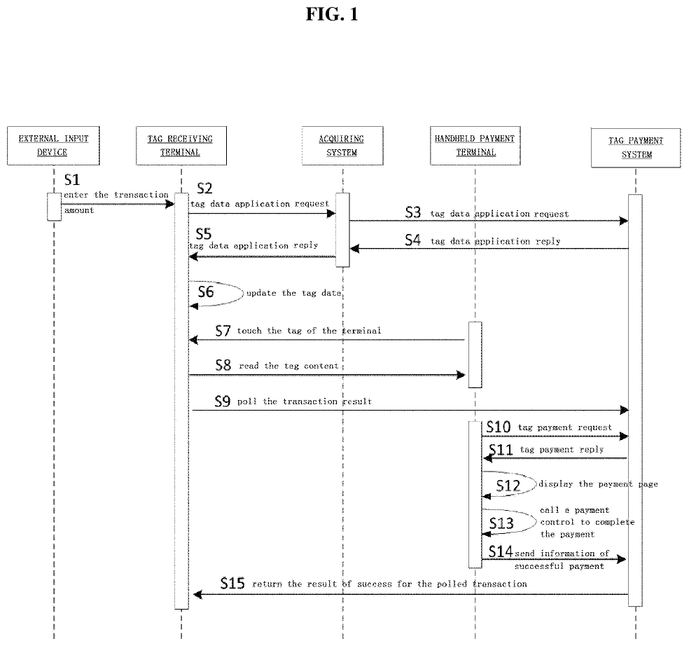

FIG. 1 is a flow chart representing the data processing method implemented based on NFC tag of one embodiment of the present invention.

The data processing method implemented based on NFC tag of one embodiment of the invention relates to an online payment method implemented based on NFC tag. In this embodiment, the online payment method is implemented by an external input device, a tag receiving terminal, an acquiring system, a handheld payment terminal (e.g., a mobile terminal of a user making a payment), and a tag payment system.

Wherein, the external input device may be externally connected with the tag receiving device, and certainly, may also be integrally formed with the tag receiving device. For example, the external input device may be an external keyboard or a keyboard integrated on the tag receiving terminal or the like.

The NFC tag in the tag receiving terminal is stored with tag data, including initiating mode transaction currency, country code, merchant name, merchant city, merchant MCC, merchant number, transaction amount, tag ID, etc., where the transaction amount is determined by the merchant input. For example, there may be initiation mode “31”, transaction currency “156”, country code “CN”, merchant name “ABC”, merchant city “shanghai”, merchant MCC “5311”, merchant number “2500034400020344500034453110004” (the latter 15 bits are the merchant identification number), transaction amount “0.00”, the institution code “220330”, and tag ID “456”.

As shown in FIG. 1, the data processing method based on NFC tag of one embodiment of the present invention comprises:

Step S1: the merchant enters the transaction amount “100.00” through the external input device and makes confirmation;

Step S2: the tag receiving terminal receives transaction amount information, generates a merchant custom order number, such as “100200”, through an MCU it is equipped with, sends a tag data application request to the acquiring system; herein, the custom order number is used for identifying this transaction, the payment state for the custom order number is set to an unpaid state when the transaction has not been paid, and is set to a state of successful payment after the transaction is completed;

Step S3: the acquiring system sends the tag data application request to the tag payment system, wherein the request element mainly includes, for example, merchant identification number “500034453110004” (the merchant identification number here is by truncating a part of the merchant number “2500034400020344500034453110004”), institution code “220330”, tag ID “456”, merchant custom order number “100200”, and transaction amount “100.00” (wherein, information such as the merchant identification number, the institution code, the tag ID and the like are equivalent to “original NFC tag data”);

Step S4: the tag payment system processes the tag data application request, saves the merchant custom order number “100200” and saves the payment state for the custom order number as unset, and sets the tag data to the valid state, and additionally may selectively set a validity period for the tag data, such as “1 day”, for example, and then sends a tag data application reply to the acquiring system;

Step S5: the acquiring system forwards the tag data application reply to the tag receiving terminal;

Step S6: after receiving the tag data application reply, the tag receiving terminal updates the transaction amount “100.00” into the tag data of the tag receiving terminal through the MCU it is equipped with, and prompts the user to touch the tag receiving terminal, such as by a voice prompt or an indicator light prompt;

Step S7: the user makes the handheld payment terminal touch a designated location of the tag receiving terminal and read the updated tag data in Step S8, such as initiation mode “31”, transaction currency “156”, country code “CN”, merchant name “ABC”, merchant city “shanghai”, merchant MCC “5311”, merchant number “2500034400020344500034453110004” (the latter 15 bits are the merchant identification number), transaction amount “100.00”, institution code “220330”, tag ID “456”; and compose an access link in a specific format, for example, composing a link using the content in the updated tag data in the format of https://nfc.123.com/nfctag/<Method Name>?<Parameter Name>=<Value> to call a tag payment page. Specifically, the format may be https://nfc.123.com/nfctag/<A>?<Tag Content 1>=<Value 1>&<Tag Content 2>=<Value 2>& . . . &<Tag Content n>=<Value n>, wherein the tag content 1 through n and values 1 through n are not original content but correspond to parameter values of the original content;

Step S9: after the updated NFC tag of the tag receiving terminal is read, polling the payment state of the merchant custom order number “100200” to judge the transaction result, such as querying the tag payment system every 0.5 second about whether the payment state of the merchant custom order number “100200” is “paid”;

Step S10: the handheld payment terminal sends a tag payment request to the tag payment system;

Step S11: after the tag payment system carries out legality verification on the tag data, returning a tag payment reply, wherein the legality verification refers to judging whether the uploaded tag data is consistent with the data stored by the tag payment system;

Step S12: the handheld payment terminal receives the tag payment reply, and displays the payment page under the condition that the legality verification is passed;

Step S13: after the user confirms the payment information, call a payment control to complete payment through the handheld payment terminal;

Step S14: the handheld payment terminal sends information of successful payment to the tag payment system;

Step S15: when the tag receiving terminal queries that the order is paid successfully in the tag payment system, feedback the information of successful payment, such as feeding back “merchant order ‘100200’, 100 yuan received’ by voice.

Next, the data processing system implemented based on NFC tag of one embodiment of the present invention will be illustrated.

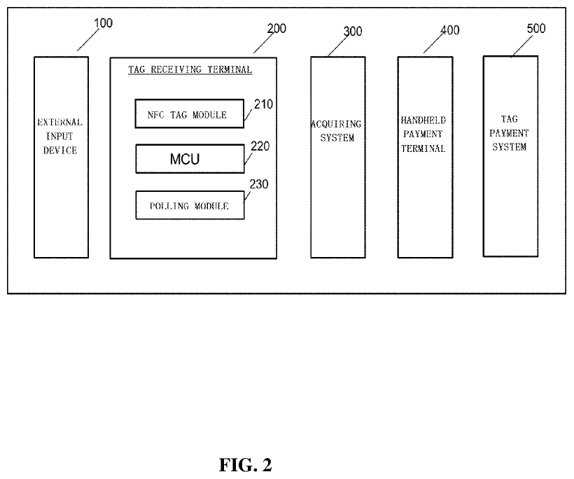

FIG. 2 is a block diagram representing the data system implemented based on NFC tag of one embodiment of the present invention.

As shown in FIG. 2, the data processing system implemented based on NFC tag of one embodiment of the present invention is provided with: an external input device 100, a tag receiving terminal 200, a handheld payment terminal 300, an acquiring system 400, and a tag payment system 500.

Wherein the external input device 100 is used for inputting amount data and providing the data to the tag receiving terminal.

The tag receiving terminal 200 is provided with:

an NFC tag module 210 for storing NFC tag data;

an MCU 220 for generating a custom order number for identifying a transaction, wherein the payment state for the custom order number is set to be an unpaid state when the transaction is not paid, and on the other hand, for issuing a tag data application request to the tag payment system based on original NFC tag data, amount data provided by the external input device, and the custom order number to acquire updated NFC tag data as described below, and for updating an NFC tag in the NFC tag module based on the updated NFC tag data as described below acquired from the tag payment system to generate an updated NFC tag, wherein the updated NFC tag includes the amount data; and

a polling module 230 for judging whether payment processing based on the updated NFC tag has been made by polling a payment state for the custom order number in the tag payment system based on the custom order number.

Wherein the tag payment system 500 is for generating the updated NFC tag data according to the tag data application request from the tag receiving terminal and saving the custom order number, and for setting the payment state for the custom order number as an unpaid state; and on the other hand, changing the payment state for the custom order number into a state of successful payment when the transaction corresponding to the custom order number is paid successfully.

The handheld payment terminal 300 is for reading the updated NFC tag from the tag receiving terminal and completing payment processing based on the updated NFC tag.

The acquiring system 400 is disposed between the tag receiving terminal 200 and the tag payment system 500 and is for communicatively connecting the two, and the acquiring system 400 may also, of course, be omitted when the tag receiving terminal 200 and the tag payment system 500 are in direct communicative connection.

Here, the external input device 100 and the tag receiving terminal 200 may be disposed separately or integrally, for example, the external input device 100 may be integrated into the tag receiving terminal 200.

Next, the data processing method implemented based on NFC tag of another embodiment of the present invention and the data processing system thereof will be illustrated.

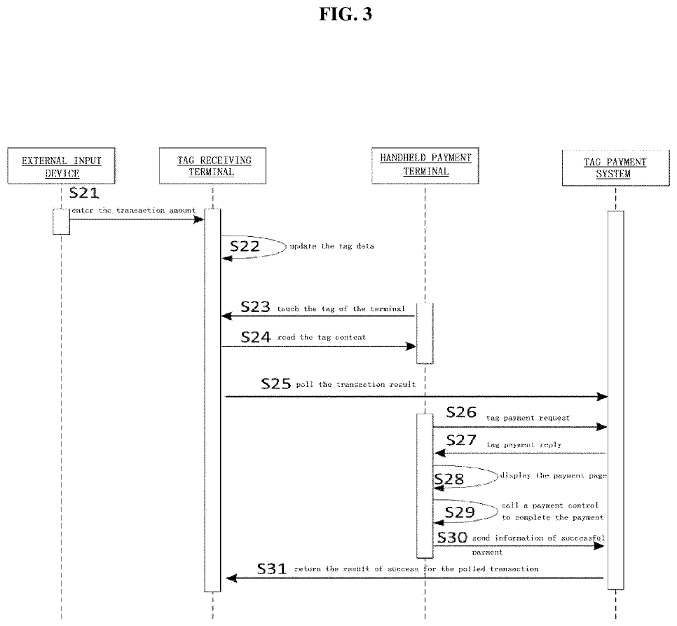

FIG. 3 is a flow chart representing the data processing method implemented based on NFC tag of another embodiment of the present invention.

The data processing method implemented based on NFC tag of another embodiment of the invention relates to an offline payment method implemented based on NFC tag. In this embodiment, the offline payment method is implemented by an external input device, a tag receiving terminal, an acquiring system, a handheld payment terminal (equivalent to the mobile phone of a user), and a tag payment system.

Step S21: the merchant enters the transaction amount “100.00” through the external input device and makes confirmation;

Step S22: after receiving the transaction amount information, the tag receiving terminal generates a merchant custom order number “100200”, and updates or writes the transaction amount “100.00” and the merchant custom order number “100200” into the tag data through the MCU, and then prompts the user to touch the tag receiving terminal, such as by a voice prompt or an indicator light prompt; wherein the custom order number is used to identify the transaction, the payment state for the custom order number is set to be an unpaid state when the transaction is not paid, and is set to be a state of successful payment after the transaction is completed;

Step S23: the user makes the handheld payment terminal touch a designated location of the tag receiving terminal;

Step S24: here, what is different from the previous embodiments is that, the tag receiving terminal is stored with a private key of the merchant, and the tag payment system is stored with a public key of the merchant; as an example, a Hash operation is performed on the tag data to acquire a Hash value “hash0”, the “hash0” is then encrypted using the merchant private key to acquire encrypted data “abcd”; when the user makes the handheld payment terminal touch the designated location of the tag receiving terminal and read the encrypted data and tag data, here the tag data may be, for example, initiation mode “31”, transaction currency “156”, country code “CN”, merchant name “ABC”, merchant city “shanghai”, merchant MCC “5311”, merchant number “2500034400020344500034453110004” (the latter 15 bits are the merchant identification number), transaction amount “100.00”, institution code “220330”, tag ID “456”, and the like; and compose an access link in a specific format, for example, composing a link using the content in the tag data in the format of https://nfc.123.com/nfctag/<Method Name>?<Parameter Name>=<Value> to call a tag payment page. Specifically, the format may be https://nfc.123.com/nfctag/<A>?<Tag Content 1>=<Value 1>&<Tag Content 2>=<Value 2>& . . . &<Tag Content n>=<Value n>, wherein the tag content 1 through n and values 1 through n are not original content but correspond to parameter values of the original content;

Step S25: after the NFC tag of the tag receiving terminal is read, polling the transaction result from the tag payment system by querying the payment state of the merchant custom order number “100200”, such as querying the tag payment system every 0.5 second about whether the payment state of the merchant custom order number “100200” is state of successful payment;

Step S26: the handheld payment terminal sends a tag payment request to the tag payment system, wherein the encrypted data “abcd” and the unencrypted tag data are sent by the mobile phone payment terminal to the tag payment system; moreover, the merchant custom order number “100200” is also sent to the tag payment system along with the tag payment request; here, as the custom order number “100200” is not paid, its payment state is an unpaid state (alternatively, the payment state may also be set to the unpaid state in step S27 by the tag payment system after receiving the custom order number “100200”);

Step S27: after the tag payment system carries out legality verification on the tag data, returning a tag payment reply, wherein the legality verification comprises, for example, the steps of: the tag payment system decrypting the encrypted data “abcd” with the public key of the merchant, acquiring a decrypted Hash value “hash1” after successful decryption, then carrying out Hash operation on the unencrypted tag data using the same Hash operation to acquire a Hash value “hash2”, and under the condition that “hash1” is equivalent to “hash2”, it indicates that the tag data is not falsified, i.e., the tag payment request is legal;

Step S28: the handheld payment terminal receives the tag payment reply, and displays the payment page under the condition that the legality verification is passed;

Step S29: after the user confirms the payment information, call a payment control to complete payment through the handheld payment terminal;

Step S30: the handheld payment terminal sends information of successful payment to the tag payment system, and the tag payment system changes the payment state for the custom order number “100200” to the state of successful payment;

Step S31: when the tag receiving terminal queries that the payment state for the custom order number in the tag payment system is “successful payment”, feedback the information of successful payment, such as feeding back “merchant order ‘100200’, 100 yuan received’ by voice.

Comparing the embodiments, the differences lie in that:

(1) in the latter embodiment, after receiving the transaction amount information, the tag receiving terminal generates a merchant custom order number “100200”, and updates or writes the transaction amount “100.00” and the merchant custom order number “100200” into the tag data through the MCU, and then prompts the user to touch the tag receiving terminal, such as by a voice prompt or an indicator light prompt;

(2) in the latter embodiment, the tag receiving terminal is stored with a private key of the merchant, and the tag payment system is stored with a public key of the merchant. In general, a Hash operation is performed on the overall tag data to acquire a Hash value “hash0”, the “hash0” is then encrypted using the merchant private key to acquire the encrypted data “abcd”; and after the encrypted data “abcd” is read by the mobile phone through NFC, the encrypted data “abcd” and the unencrypted tag data are sent by the mobile phone payment terminal to the tag payment system during sending the tag payment request. The tag payment system decrypts the encrypted data “abcd” with the public key of the merchant, and acquires a decrypted Hash value “hash1” after successful decryption, then carries out Hash operation on the unencrypted tag data using the same Hash operation to acquire a Hash value “hash2”, and under the condition that “hash1” is equivalent to “hash2”, it indicates that the tag data is not falsified, i.e., the tag payment request is legal;

(3) in the latter embodiment, the merchant custom order number “100200” will also be sent through the tag payment request process.

Next, the data processing system implemented based on NFC tag of another embodiment of the present invention will be illustrated.

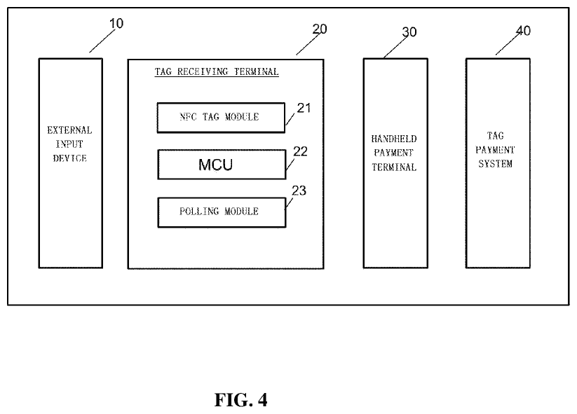

FIG. 4 is a block diagram representing the data system implemented based on NFC tag of another embodiment of the present invention.

The data system implemented based on NFC tag of another embodiment of the present invention is provided with: an external input device 10, a tag receiving terminal 20, a handheld payment terminal 30, and a tag payment system 40.

The external input device 10 is for inputting the amount data and providing the amount data to the tag receiving terminal 20.

The tag receiving terminal 20 is provided with:

an NFC tag module 21 for storing NFC tag data;

an MCU 22 for generating a custom order number for identifying a transaction, wherein the payment state for the custom order number is set to be an unpaid state when the transaction is not paid, and on the other hand, for updating the amount data and the custom order number into the NFC tag data stored in the NFC tag module to generate an updated NFC tag; and

a polling module 23 for judging whether payment processing based on the updated NFC tag is performed by polling the payment state for the custom order number in the tag payment system.

The handheld payment terminal 30 is for reading the updated NFC tag, issuing a payment request to the tag payment system 40 based on the updated NFC tag, and receiving a payment reply from the tag payment system 40, wherein, the payment request also includes the custom order number and the payment state for the custom order number.

The tag payment system 40 is for receiving the payment request from the handheld payment terminal 30 and returning a payment reply to the handheld payment terminal 30, and changing the payment state for the custom order number to a state of successful payment when the transaction corresponding to the custom order number is paid successfully.

Here, the external input device 10 and the tag receiving terminal 20 may be disposed separately or integrally, for example, the external input device 10 may be integrated into the tag receiving terminal 20.

The data processing method implemented based on NFC tag and the data processing system based on NFC tag according to embodiments of the invention do not require a user to enter a transaction amount on the mobile phone terminal, but instead the transaction amount is input by the merchant and updated into the NFC tag, thereby reducing the complexity of user operation, enhancing the user's payment experience, and meanwhile, reducing the difficulty for the merchant to confirm payment, and the experience at both the user side and the merchant side can be improved at the same time.

The above example mainly illustrates the data processing method implemented based on NFC tag and the data processing system based on NFC tag according to embodiments of the invention. While only some certain embodiments of the present invention have been described, it will be understood by those of ordinary skill in the art that embodiments of the present invention may be embodied in many other forms without departing from its spirit and scope. Accordingly, the illustrated examples and embodiments are to be considered as illustrative and not restrictive, and embodiments of the invention may encompass various modifications and substitutions without departing from the spirit and scope of the invention as defined by the appended claims.

1. A data processing method implemented based on NFC tag, comprising:
an amount data acquisition step to acquire amount data;
a custom order number generation step to generate a custom order number for identifying a transaction, wherein a payment state for the custom order number is set to be an unpaid state when the transaction is not paid, and is set to be a state of successful payment after the transaction is completed;
a tag data application step to issue a tag data application request based on original NFC tag data, the acquired amount data and the custom order number;
a tag data reply step to generate updated NFC tag data based on the tag data application request and save the custom order number, and set the payment state for the custom order number to be the unpaid state;
a tag updating step to update the NFC tag based on the updated NFC tag data and generate an updated NFC tag, wherein the updated NFC tag includes the amount data; and
a tag payment step to read the updated NFC tag, complete payment processing based on the updated NFC tag, and change the payment state for the custom order number to the state of successful payment under the condition that the payment is successful.

2. The data processing method implemented based on NFC tag of claim 1, further comprising after the reading step of the updated tag:
a polling step to judge whether the payment processing based on the updated NFC tag is performed by polling the payment state for the custom order number based on the custom order number.

3. The data processing method implemented based on NFC tag of claim 1, wherein the tag payment step comprises:
reading the updated NFC tag, and composing an access link in a specific format to send a tag payment request, wherein the tag payment request includes the updated NFC tag data;
after carrying out legality verification on the updated tag data, returning a tag payment reply;
calling a payment control to complete the payment based on the tag payment reply;
sending information indicating successful payment, and changing the payment state for the custom order number according to the information indicating successful payment.

4. A data processing method implemented based on NFC tag, comprising:
an amount data acquisition step to acquire amount data;
a custom order number generation step to generate a custom order number for identifying a transaction, wherein a payment state for the custom order number is set to be an unpaid state when the transaction is not paid, and is set to be a state of successful payment after the transaction is completed;
a tag data application step to issue a tag data application request based on original NFC tag data, the acquired amount data and the custom order number;
a tag data reply receiving step to receive a tag data reply based on the tag application request, wherein for the tag data reply, generate updated NFC tag data based on the tag data application request; and
a tag updating step to update the NFC tag based on the updated NFC tag data to obtain an updated NFC tag for payment processing, wherein the updated NFC tag includes the amount data.

5. The data processing method implemented based on NFC tag of claim 4, further comprising after the reading step of the updated tag:
a polling step to judge whether the payment processing based on the updated NFC tag is performed by polling the payment state for the custom order number.

6. A data processing method implemented based on NFC tag, comprising:
an amount data acquisition step to acquire amount data;
a custom order number generation step to generate a custom order number for identifying a transaction, wherein a payment state for the custom order number is set to be an unpaid state when the transaction is not paid, and is set to be a state of successful payment after the transaction is completed;
a tag updating step to update the NFC tag data based on the amount data and the custom order number to obtain an updated NFC tag, wherein the updated NFC tag comprises the amount data; and
a tag payment step to read the updated NFC tag, complete issuing a payment request based on the updated NFC tag and receive a payment reply, wherein the payment request further includes the custom order number and the payment state for the custom order number, and change the payment state for the custom order number to a state of successful payment under the condition that the payment is successful.

7. The data processing method implemented based on NFC tag of claim 6, further comprising after the tag updating step:
a polling step to judge whether the payment processing based on the updated NFC tag is performed by polling the payment state for the custom order number.

8. The data processing method implemented based on NFC tag of claim 6, wherein the tag payment step comprises:
reading the updated NFC tag and encrypting encrypted data of the updated NFC tag with a private key;
composing an access links in a specific format to issue a tag payment request, wherein the tag payment request includes the updated NFC tag data, the encrypted data, the custom order number, and the payment state of the custom order number;
after decrypting the encrypted data with a public key and carrying out legality verification on the updated tag data in the tag payment request, returning a tag payment reply;
calling a payment control to complete payment based on the tag payment reply;
sending information indicating successful payment, and changing the payment state for the custom order number according to the information indicating successful payment.

9. A data processing method implemented based on NFC tag, comprising:
an amount data acquisition step to acquire amount data;
a custom order number generation step to generate a custom order number for identifying a transaction, a payment state for the custom order number being set to be an unpaid state when the transaction is not paid, and being set to be a state of successful payment after the transaction is completed; and
a tag updating step to update the NFC tag data based on the amount data and the custom order number to generate an updated NFC tag for payment processing, wherein the updated NFC tag includes the amount data.

10. The data processing method implemented based on NFC tag of claim 9, further comprising after the tag updating step:
a polling step to judge whether the payment processing based on the updated NFC tag is performed by polling the payment state for the custom order number.

11. A data processing system implemented based on NFC tag, comprising: an external input device, a tag receiving terminal, a handheld payment terminal and a tag payment system,
the external input device being for inputting amount data and providing the amount data to the tag receiving terminal,
the tag receiving terminal comprising:
an NFC tag module for storing NFC tag data;
an MCU for generating a custom order number for identifying a transaction, wherein a payment state for the custom order number is set to be an unpaid state when the transaction is not paid, on the other hand, for issuing a tag data application request to the tag payment system based on original NFC tag data, amount data provided by the external input device, and the custom order number to acquire updated NFC tag data as described below, and for updating an NFC tag in the NFC tag module based on the updated NFC tag data as described below acquired from the tag payment system to generate an updated NFC tag, wherein the updated NFC tag includes the amount data,
the tag payment system being for generating the updated NFC tag data according to the tag data application request from the tag receiving terminal and saving the custom order number, and for setting the payment state for the custom order number as an unpaid state; and on the other hand, changing the payment state for the custom order number into a state of successful payment when the transaction corresponding to the custom order number is paid successfully,
the handheld payment terminal being for reading the updated NFC tag from the tag receiving terminal and completing payment processing based on the updated NFC tag.

12. The data processing system implemented based on NFC tag of claim 11, wherein the tag receiving terminal further comprises:
a polling module for judging whether the payment processing based on the updated NFC tag is performed by polling the payment state for the custom order number in the tag payment system based on the custom order number.

13. The data processing system implemented based on NFC tag of claim 11, wherein,
the external input device and the tag receiving terminal are disposed separately,
or the external input device is integrated into the tag receiving terminal.

14. A tag receiving terminal, comprising:
an external or built-in input device for inputting amount data;
an NFC tag module for storing NFC tag data; and
an MCU for generating a custom order number for identifying a transaction, wherein a payment state for the custom order number is set to be an unpaid state when the transaction is not paid, and on the other hand, for issuing a tag data application request based on original NFC tag data, amount data provided by the input device, and the custom order number to acquire updated NFC tag data, and for updating an NFC tag in the NFC tag module based on the acquired updated NFC tag data to generate an updated NFC tag, wherein the updated NFC tag includes the amount data.

15. The tag receiving terminal of claim 14, further comprising:
a polling module for judging whether the payment processing based on the updated NFC tag is performed by polling the payment state for the custom order number based on the custom order number.

16. A data processing system implemented based on NFC tag, comprising: an external input device, a tag receiving terminal, a handheld payment terminal and a tag payment system,
the external input device being for inputting amount data and providing the amount data to the tag receiving terminal,
the tag receiving terminal comprising:
an NFC tag module for storing NFC tag data; and
an MCU for generating a custom order number for identifying a transaction, wherein a payment state for the custom order number is set to be an unpaid state when the transaction is not paid, and on the other hand, for updating the amount data and the custom order number into the NFC tag data stored in the NFC tag module to generate an updated NFC tag,
the handheld payment terminal being for reading the updated NFC tag, issuing a payment request to the tag payment system based on the updated NFC tag, and receiving a payment reply from the tag payment system, wherein, the payment request further includes the custom order number and the payment state for the custom order number,
the tag payment system being for receiving the payment request from the handheld payment terminal and returning a payment reply to the handheld payment terminal, and changing the payment state for the custom order number to a state of successful payment when the transaction corresponding to the custom order number is paid successfully.

17. The data processing system implemented based on NFC tag of claim 16, wherein the tag receiving terminal further comprises:
a polling module for judging whether the payment processing based on the updated NFC tag is performed by polling the payment state for the custom order number in the tag payment system.

18. The data processing system implemented based on NFC tag of claim 16, wherein,
the external input device and the tag receiving terminal are disposed separately, or
the external input device is integrated into the tag receiving terminal.

19. A tag receiving terminal, comprising:
an external or built-in input device for inputting amount data;
an NFC tag module for storing NFC tag data; and
an MCU for generating a custom order number for identifying a transaction, wherein a payment state for the custom order number is set to be an unpaid state when the transaction is not paid, and on the other hand, for updating the amount data obtained by the input device and the custom order number into the NFC tag data stored in the NFC tag module to generate an updated NFC tag.

20. The tag receiving terminal of claim 19, further comprising:
a polling module for judging whether the payment processing based on the updated NFC tag is performed by polling the payment state for the custom order number.

21. (canceled)

22. (canceled)
